(19) United States
(12) Patent Application Publication
(10) Pub. No.: US 2015/0167360 A1
(43) Pub. Date: Jun. 18, 2015

(54) DOOR LOCK DEVICE FOR VEHICLE

(71) Applicant: Hyundai Motor Company, Seoul (KR)

(72) Inventor: Jae Hoon CHUNG, Seongnam-si (KR)

(73) Assignee: Hyundai Motor Company, Seoul (KR)

(21) Appl. No.: 14/322,652

(22) Filed: Jul. 2, 2014

(30) Foreign Application Priority Data
Dec. 18, 2013 (KR) 10-2013-0157739
Dec. 18, 2013 (KR) 10-2013-0157919

(51) Int. Cl. E05B 85/00

(52) U.S. Cl. CPC E05B 85/00

(57) ABSTRACT

A door lock device for a vehicle may include a key set and a latch device, an operating rod configured to include a first rod connected with the key set and a second rod connected to the latch device and provide an operating force depending on the key set operation as an operating force of the latch device in a state in which the first rod and the second are connected with each other, and a rupture part configured to be provided at a connection portion between the first rod and the second rod of the operating rod and be ruptured when a force is applied in a direction different from an operating direction in which the operating force of the operating rod is applied.

### CROSS REFERENCE TO RELATED APPLICATION

The present application claims priorities both of Korean Patent Applications Numbers 10-2013-0157919 and 10-2013-0157739, filed on Dec. 18, 2013, the entire contents of which application are incorporated herein for all purposes by this reference.

### BACKGROUND OF INVENTION

1. Technical Field

The present invention relates to a door lock device for a vehicle capable of preventing a vehicle theft by making a door an unlocking disabled state at the time of an operation to forcibly unlock a locking state of a vehicle door.

2. Description of Related Art

To prevent trespass on a vehicle from the outside, a vehicle door is configured to be able to be locked and unlocked. As illustrated in FIG. 1, a door lock device according to the related art is provided with a door lock 10 configured to be mounted in a door and selectively operate locking and unlocking of the door depending on an operation after an insertion of a key, a door latch 20 which is fastened with a door strike to keep a closed state of the door, and a rod 30 configured to be interconnected to the door lock 10 and the door latch 20 to transfer an operating force to the door latch 20 at the time of operating the key through the door lock 10, thereby locking or unlocking the door.

However, in the case of the door lock device according to the related art, when equipment is inserted into the rod 30 through a door outside belt portion of a vehicle to be able to pull the rod 30 and then forcibly pull the rod 30 up, an unlocking mechanism of the door latch 20 is operated to be able to open the door.

This may be implemented since the rod 30 is exposed inside the door. To solve the above problem, a protector to cover an upper portion of the rod 30 may be mounted, but a layout inside the door may be different for each vehicle model and interference between parts inside the door may be caused, such that a problem that protectors for each vehicle model need to be designed may occur.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to prevent a vehicle theft by making a door an unlocking disabled state at the time of an operation to forcibly unlock a locking state of the door. Further, the present invention has been made in an effort to provide a door lock device for a vehicle which is free from a limitation in layout by removing a necessity for an installation space for an anti-theft device and prevents interference with other parts.

According to various aspects of the present invention, there is provided a door lock device for a vehicle, including: a key set configured to include a rotating link which rotates depending on an operation of an inserted key, a latch device configured to receive an operating force from the key set to selectively lock or unlock a door, an operating rod configured to connect the rotating link of the key set with the latch device to convert a rotating displacement of the rotating link into a linear displacement and provide the converted linear displacement to the latch device as the operating force, and a rupture part configured to be provided between both ends of the operating rod to break the operating rod when an external force other than the operating force provided from the rotating link to the latch device is applied to the operating rod.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a door lock device according to the related art;

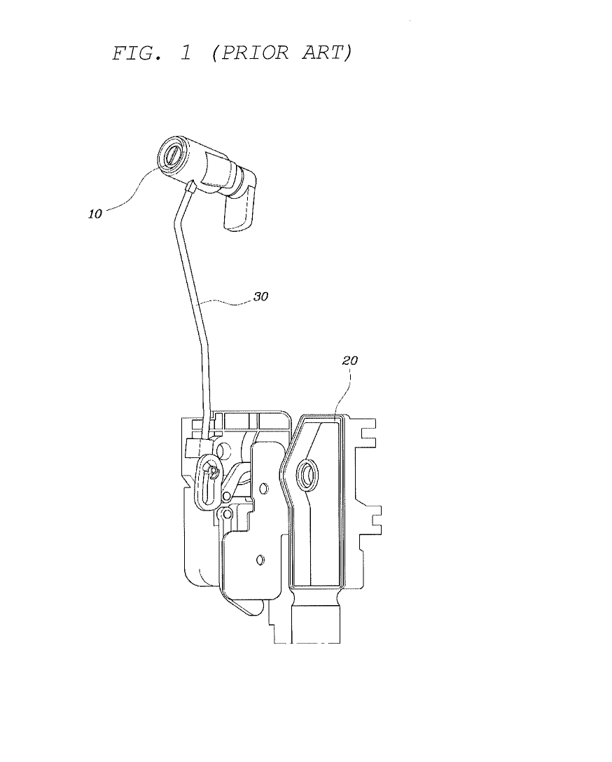

FIG. 2 is a diagram illustrating an exemplary door lock device for a vehicle according to the present invention;

FIG. 3 is an assembling diagram illustrating the door lock device for a vehicle illustrated in FIG. 2;

FIG. 4 is a diagram illustrating an operating mechanism and a rupture member in the door lock device for a vehicle illustrated in FIG. 2;

FIGS. 5 and 6 are diagrams illustrating an operating state of the door lock device for a vehicle illustrated in FIG. 2;

FIG. 7 is a diagram illustrating another exemplary door lock device for a vehicle according to the present invention;

FIG. 8 is an exploded view of the door lock device for a vehicle illustrated in FIG. 7;

FIG. 9 is a cross-sectional view of the door lock device for a vehicle illustrated in FIG. 7; and

FIG. 10 is a diagram illustrating still another exemplary door lock device for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Generally, a door lock device for a vehicle according to various embodiments of the present invention includes a key set 100 configured to include a rotating link 120 which rotates depending on an operation of an inserted key, a latch device 200 configured to receive an operating force from the key set to selectively lock or unlock the door, an operating rod 300 configured to connect the rotating link of the key set with the latch device to convert a rotating displacement of the rotating link into a linear displacement and provide the converted linear displacement to the latch device as the operating force, and a rupture part 460 configured to be provided between both ends of the operating rod to break the operating rod when an external force is applied to the operating rod besides the operating force provided from the rotating link to the latch device.

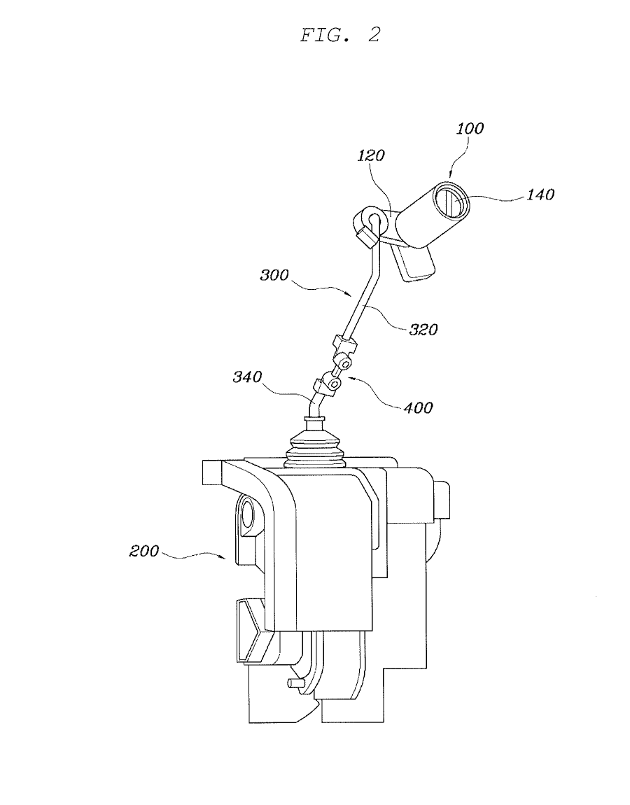

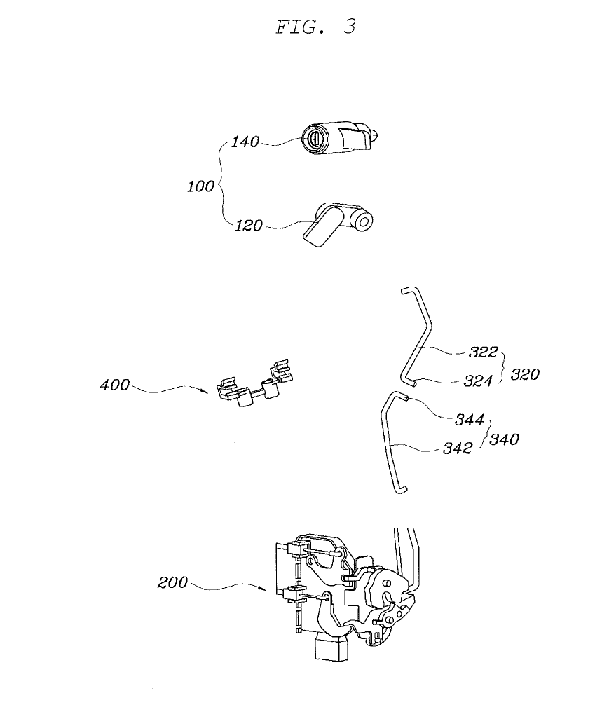

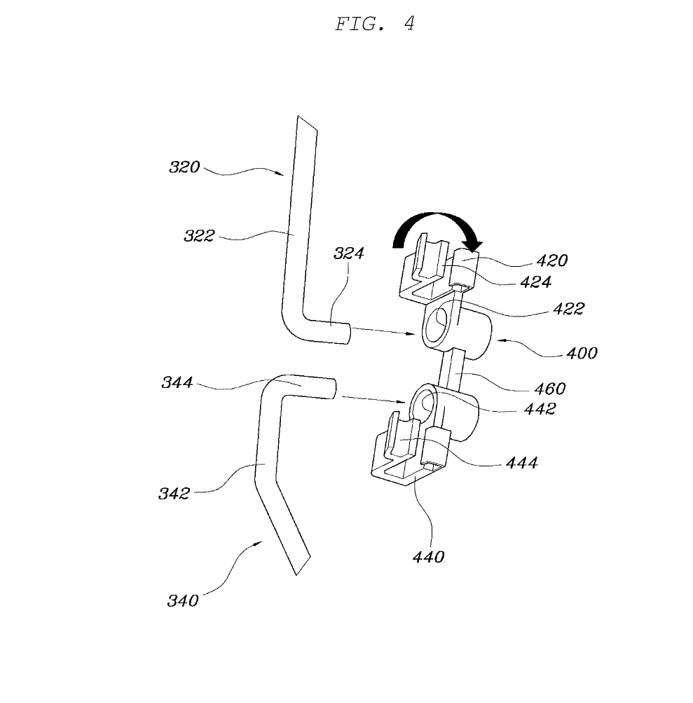

As illustrated in FIGS. 2 to 6, according to the first exemplar embodiment of the present invention, the operating rod 300 is configured to include a first rod 320 configured to be connected with the rotating link of the key set, a second rod 340 which is connected with the latch device 200, and a rupture member 400, in which the first rod and the second rod are configured to transfer an operating force depending on the key operation as the operating force of the latch device 200 in the state in which the first and second rods are connected with each other by the rupture member.

Further, according to various embodiments of the present invention, the rupture member is provided with the rupture part 460 and thus is ruptured when an force is applied in a direction different from the operating direction in which the operating force of the operating rod is transferred, such that the connection state between the first rod 320 and the second rod 340 may be separated. Here, the operating direction in which the operating force of the operating rod 300 is transferred substantially means a longitudinal direction of the operating rod 300.

The key set 100 is provided with a key insertion hole 140 into which a key may be inserted and the rotating link 120 rotates depending on the operation of the key inserted into the key insertion hole 140. The latch device 200 is configured to selectively lock or unlock the door when the key inserted into the key set 100 is operated.

The key set 100 and the latch device 200 may be parts similar to or the same as those that are already known, and the lock or unlock operation of the latch device 200 depending on the key operation of the key set 100 may be known to those skilled in the art and therefore the detailed description thereof will be omitted.

The operating rod 300 is provided to connect the rotating link 120 of the key set 100 with the latch device 200. That is, in the operating rod 300, one end of the first rod 320 is rotatably hinge pin-joined or locked with the rotating link 120 and the other end of the second rod 340 is connected with the latch device 200. Further, the other end of the first rod 320 and one end of the second rod 340 are connected with each other by the rupture member 400.

By doing so, the rotating link 130 rotating depending on the key operation of the key set 100 pulls or pushes the operating rod 300 and the locking and unlocking operation of the latch device 200 is performed by the pulling and pushing operation of the operating rod 300 to lock and unlock the door.

Describing in detail various embodiments of the present invention, the first rod 320 of the operating rod 300 may be configured to include a first extending part 322 which is connected with the rotating link 120 of the key set 100 and extend to the latch device 200 and a first bending part 324 which is bent at an end of the first extending part 322 and the second rod 340 may be configured to include a second extending part 342 which is connected with the latch device 200 and extend to correspond to the first rod 320 and a second bending part 344 which is bent at an end of the second extending part 342.

As such, the first rod 320 and the second rod 340 configuring the operating rod 300 according to various embodiments of the present invention are not formed simply in a bar shape, but the ends thereof are bent to be able to improve a combining strength with the rupture member 400.

In the operating rod 300, although the first rod 320 is provided with the first bending part 324 and the second rod 340 is provided with the second bending part 344 and the first rod 320 and the second rod 340 are configured to be connected with each other by the rupture member 400, the first rod 320, the rupture member 400, and the second rod 340 have a shape such as one rod which may generally transfer the linear displacement from the key set to the latch device.

As illustrated in FIG. 2, the operating rod 300 according to various embodiments of the present invention is connected between the upper key set 100 and the lower latch device 200 and therefore is configured to vertically move. According to various embodiments of the present invention, the operating rod 300 is configured to be separated into the first rod 320 and the second rod 340, the first rod 320 and the second rod 340 are connected with each other by the rupture member 400, and when the first rod 320 and the second rod 340 have a straight shape such as the simple bar shape as in a second exemplary embodiment of the present invention to be described below, the rupture member 400 may be slipped between the first rod 320 and the second rod 340 at the time of a linear motion between the first rod 320 and the second rod 340.

Therefore, according to various embodiments of the present invention, the first rod 320 and the second rod 340 are each provided with the bending parts 324 and 344 and are connected with each other by the rupture member 400, such that the operating force depending on a vertical motion may be smoothly and stably transferred.

Generally, the key set 100 is disposed at an upper portion of the door and the latch device 200 is disposed at a lower portion thereof. In this case, although the operating rod 300 according to various embodiments of the present invention moves in a vertical direction as described above, the vertical direction means a direction in which the operating force between the key set 100 and the latch device 200 is applied and therefore is not limited only to expression called as vertical.

That is, the movement of the operating rod in the vertical direction is mentioned as the detailed one embodiment in which the operating rod linearly connecting between the latch devices moves along the longitudinal direction thereof from the key set to transfer the operating force of the key set as the operating force of the latch device.

According to various embodiments of the present invention, the first bending part 324 and the second bending part 344 of the operating rod 300 may be bent in the vertical direction to the operating direction (that is, the longitudinal direction of the operating rod) in which the operating force is applied. Further, the first bending part 324 and the second bending part 344 of the operating rod 300 may be bent in the same or substantially the same direction.

As such, the first bending part 324 and the second bending part 344 of the operating rod 300 are bent in the vertical direction to the direction in which the operating force is applied and are connected with the rupture member in the state in which the bending directions of the first bending part 324 and the second bending part 344 are bent in the same or substantially the same direction, such that the operating force through the operating rod 300 may be more smoothly and certainly transferred.

Further, the rupture member 400 connected with the first rod 320 and the second rod 340 of the operating rod 300 may be connected with the first rod 320 and the second rod 340 with more strong combining strength than the second exemplary embodiment of the present invention, thereby simplifying the operation process and improving the operation convenience.

Meanwhile, the rupture member 400 may include a first connection part 420 and a second connection part 440 configured to be connected to the first rod 320 and the second rod 340, respectively and a rupture part 460 configured to be ruptured when a force is applied in a direction different from the operation direction of the operating rod 300.

That is, the rupture member 400 is provided with the first connection part 420 and the second connection part 440 which are each connected with the first rod 320 and the second rod 340 and the first rod 320 and the second rod 340 are connected with each other by the rupture part 460 which connects the first connection part 420 with the second connection part 440, such that the operating force depending on the key operation may be transferred to the latch device 200.

Here, the rupture part 460 of the rupture member 400 is configured to be ruptured when a force is applied in a direction different from the operating direction of the operating rod 300, in which the rupture part 460 is made of a material different from the first connection part 420 and the second connection part 440 and thus may be formed to be ruptured when an external force having or exceeding a preset size is applied. Further, a rupture strength of the rupture part 460 may be freely set by various methods for forming a notch in the rupture part 460, and the like.

Additionally describing this, the rupture part 460 of the rupture member 400 is connected between the first connection part 420 and the second connection part 440 as usual to apply an operating force F1 representing a tensile force or a compressive force applied in the longitudinal direction of the operating rod 300 between the key set 100 and the latch device 200 by the rotating link 120 depending on the key operation of the key set 100.

In this state, to forcibly open the door, when the operating rod 300 is externally forcibly pulled in another direction, not in the longitudinal direction of the operating rod, by using an equipment, a shearing force F2 is generated in the rupture part 460 of the rupture member 400 and thus ruptures the rupture part 460. As such, as the rupture part 460 of the rupture member 400 is ruptured, the first rod 320 and the second rod 340 of the operating rod 300 are separated from each other to limit the unlocking operation of the latch device 200.

Meanwhile, describing the structure to easily join the rupture member 400 with the operating rod 300, the first connection part 420 and the second connection part 440 of the rupture member 400 may each be provided with fixing hole parts 422 and 442 into which the first bending part 324 and the second bending part 344 of the operating rod 300 are inserted.

That is, the first connecting part 420 and the second connecting part 440 of the rupture member 400 are each provided with the fixing hole parts 422 and 442 into which the first bending part 324 and the second bending part 344 of the operating rod 300 may be inserted, such that the operating rod 300 and the rupture member 400 are connected with each other.

Here, the first bending part 324 and the second bending part 344 of the operating rod 300 are bent in the vertical direction to the direction in which the operating force is applied and the fixing hole parts 422 and 442 of the rupture member 400 are formed in a horizontal direction to correspond thereto, such that the first bending part 324 and the second bending part 344 may be easily inserted.

However, the rupture part 460 of the rupture member 400 is formed on outer circumferential surfaces of the fixing hole parts 422 and 442 which are each formed in the first connection part 420 and the second connection part 440 and thus it is preferable to connect the first connection part 420 with the second connection part 440.

According to various embodiments of the present invention, the first bending part 324 and the second bending part 344 are formed at the ends of the first rod 320 and the second rod 340 and the outer circumferential surfaces of the fixing hole parts 422 and 442 of the first connection part 420 and the second connection part 440 of the rupture member 400 which are joined with the ends of each rod 320 and 340 are provided with the rupture part 460 to be able to shorten the length of the rupture part 460.

Further, as a gap between the first connection part 420 and the second connection part 440 of the rupture member 400 is connected with the rupture part 460, when the external force is generated, a rupture action is smoothly performed without the interface with other parts.

As described above, as the first bending part 324 and the second bending part 344 of the operating rod 300 are inserted through the fixing hole parts 422 and 442 of the rupture member 400, the operating force applied in the vertical direction between the key set 100 and the latch device 200 may be smoothly transferred without losing the applied operating force and a combining force between the rupture member 400 and the operating rod 300 may be also improved.

Meanwhile, the first connection part 420 and the second connection part 440 of the rupture member 400 may be each provided with joining parts 424 and 444 which enclose the first extending part 322 and the second extending part 342 of the opening rod 300.

Here, each of the joining part 424 and 444 of the first connection part 420 and the second connection part 440 is provided with combining parts to mount the rupture member 400 on the operating rod 300 when enclosing each of the extending parts 322 and 342 of the operating rod 300 and then being fastened therewith.

That is, the first connecting part 420 and the second connecting part 440 of the rupture member 400 are each provided with the joining parts 424 and 444 into which the first extending part 322 and the second extending part 342 of the operating rod 300 may be inserted, such that the operating rod 300 and the rupture member 400 are connected with each other.

Here, the joining parts 424 and 444 which are each formed in the first connection part 420 and the second connection part 440 of the rupture member 400 are provided with the combining part, such that the rupture member 400 may be easily mounted on the first extending part 322 and the second extending part 342 of the opening rod 300 through the joining parts 424 and 444 provided with the combining part. As the combining part, various combining methods, such as a clip structure, a hook structure, and the like may be used, but through the change in design, various methods may be applied and therefore only any one method is not used.

As described above, when the rupture member 400 according to various embodiments of the present invention is connected to the first rod 320 and the second rod 340, the first bending part 324 and the second bending part 344 are fitted in the fixing hole parts 422 and 442 of the rupture member 400. Further, the joining parts 424 and 444 each formed in the first connection part 420 and the second connection part 440 of the rupture member 400 enclose the first extending part 322 and the second extending part 342 and then are fastened therewith by the combining part, such that the rupture member 400 may be mounted on the first rod 320 and the second rod 340 without moving in all directions.

Further, when the rupture member 400 is connected with the first rod 320 and the second rod 340, the convenience of the operator is improved and the operation time is shortened, by the simple operation process as described above.

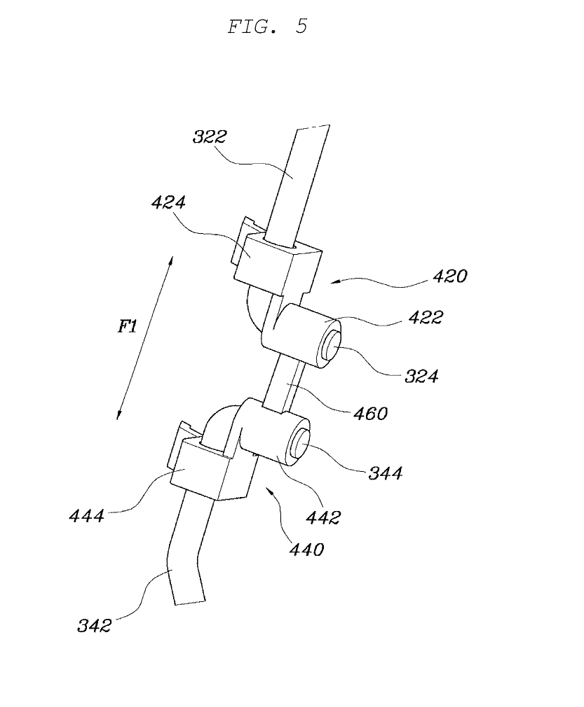

Meanwhile, describing the operation of the rupture member 400 to prevent the door theft, as illustrated in FIGS. 5 and 6, the rupture member 400 is each connected with the first rod 320 and the second rod 340 of the operating rod 300 by the first connection part 420 and the second connection part 440 and the rupture part 460 is connected between the first connection part 420 and the second connection part 440. In the normal case, as the operating force by the rotation of the rotating link 120 depending on the key operation of the key set 100 is transferred to the latch device 200 through the operating rod 300 and the rupture member 400, only the operating force F1 which is the tensile force or the compressive force is applied between the key set 100 and the latch device 200.

Meanwhile, to forcibly open the door, when the operating rod 300 is externally forcibly pulled in another direction, not in the longitudinal direction of the operating rod, by using the specific equipment, the shearing force F2 which is a force in a direction different from the operation force F1 is generated in the rupture part 460 of the rupture member 400 and thus ruptures the rupture part 460. As such, as the rupture part 460 of the rupture member 400 is ruptured, the first rod 320 and the second rod 340 of the operating rod 300 are separated from each other to be able to limit the locking or unlocking operation of the latch device 200.

In the door lock device for a vehicle having the foregoing structure, the operating rod 300 connecting the key set 100 with the latch device 200 is configured to be separated, the respective separated rods are connected with each other through the rupture member 400, and when an external force is applied to forcibly unlock the locking state of the door, the rupture member 400 is cut and thus separates the operating rod 300. As such, the vehicle theft may be prevented by preventing the locking state of the door from being unlocked.

Further, according to various embodiments of the present invention, the existing operating rod is configured to be separated and only the rupture member which connects the separated operating rods with each other is applied, such that the necessity for the additional installation space for the anti-theft device is removed, thereby being free from the limitation in layout and preventing the interference with other parts.

In addition, according to various embodiments of the present invention, it is possible to reduce the working time to apply the anti-theft device, improve the assembling convenience, and reduce the manufacturing costs.

Further, the separated operating rods is again connected with each other by replacing only the rupture member when the rupture member is ruptured due to the occurrence of the theft situation, such that the door lock device for a vehicle may be easily recovered to the normal state.

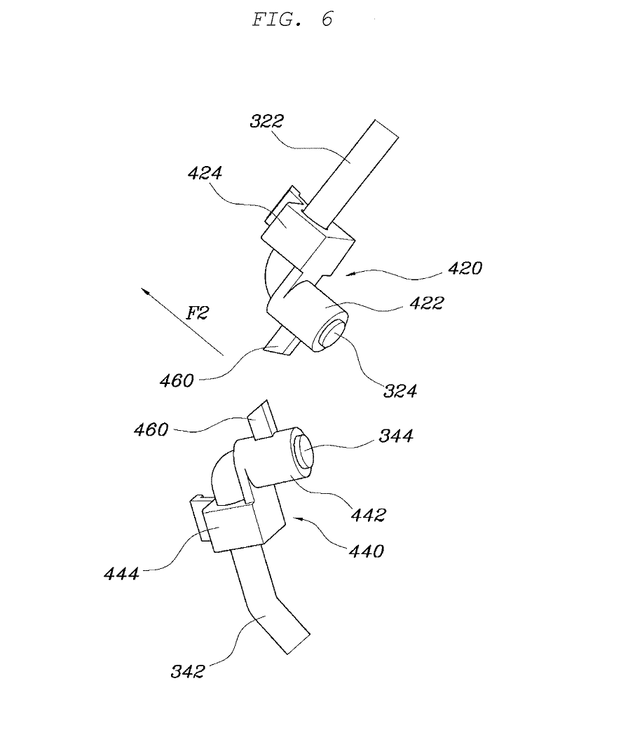

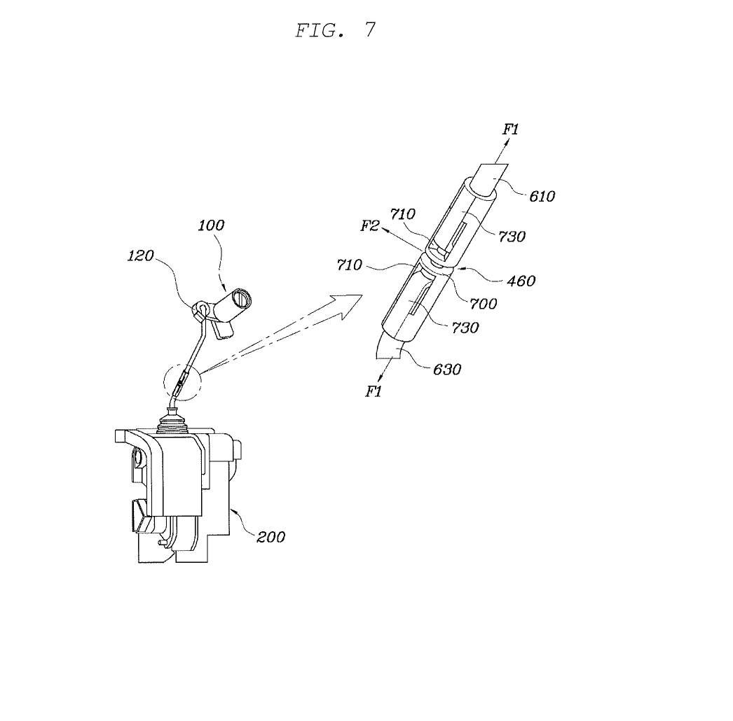

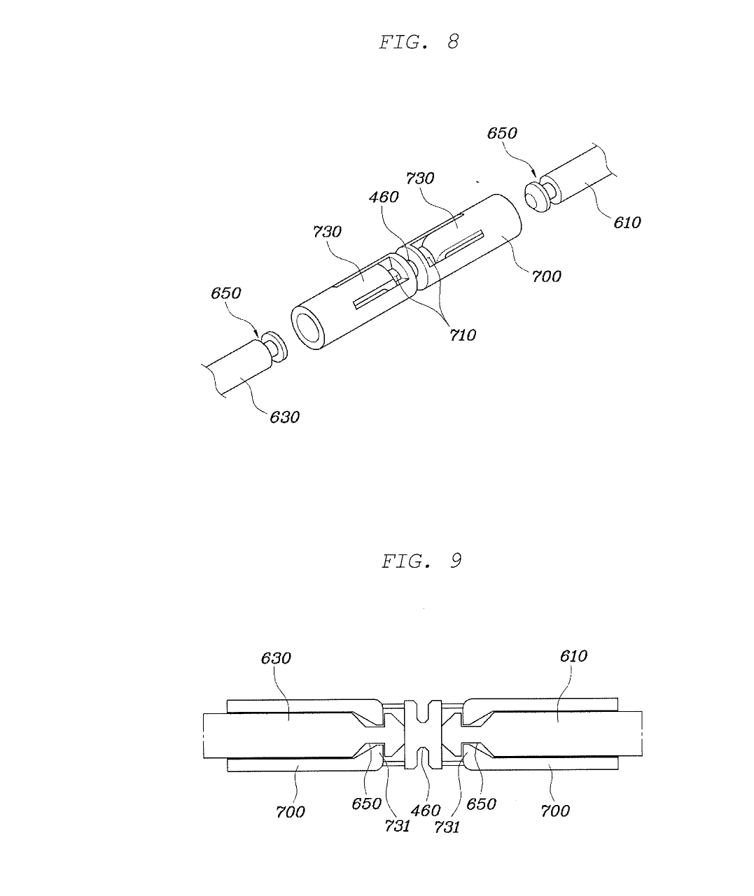

FIGS. 7 to 9 illustrate the door lock device for a vehicle according a second exemplary embodiment of the present invention, in which in the door lock device for a vehicle according to the second exemplary embodiment of the present invention, in addition to the common parts, the operating rod 300 has a link rod 610 of which one end connected with the rotating link 120 and has a latch rod 630 of which one end connected with the latch device 200, and has a connection link 700 of which both ends connected with each of the other ends of the link rod 610 and the latch rod 630.

The link rod 610 and the latch rod 630 forming the operating rod 300 is functionally substantially similar to the first rod and the second rod according to the first exemplary embodiment of the present invention, but in detail, are represented by separate names due to the difference in a characteristic shape thereof, and the connection link 700 functionally corresponds to the rupture member according to the first exemplary embodiment of the present invention and thus is represented by a separate name due to the difference in a characteristic shape thereof.

The operating rod 300 is provided to connect the rotating link 120 of the key set 100 with the latch device 200, and one end thereof is rotatably hinge pin-joined or locked with the rotating link 120, the other end thereof is pin-joined or locked with the latch device 200 to pull or push the operating rod 300 in the longitudinal direction of the operating rod at the time of rotating the rotating link 120, and the latch device 200 has a structure to lock or unlock the door by the operating force F1 which is a pulling or pushing force.

The operating rod 300 is configured to include two independent rods and the connection link 700 connecting the two rods with each other, such that the shape of the rupture part 460 and the rupture strength may be freely changed depending on the shape and material of the connection link 700.

For example, the rupture part 460 between both ends of the connection link 700 is made of a material different from both ends thereof, such that the rupture part 460 may be ruptured when the shearing force having a preset size is applied from the outside or the notch is formed between both ends of the connection link 700 along the circumference of the connection link 700, such that the rupture may occur when the shearing force F2 is applied.

Additionally describing the shearing force F2, the shearing force is not generated as usual. Meanwhile, as usual, the operating rod 300 and the connection link 700 are applied with only the operating force F1 in a direction corresponding to the longitudinal direction of the operating rod as illustrated in FIG. 7 by the rotating link 120, but when the operating rod 300 is pulled by inserting the equipment by which the end is locked with the operating rod 300 through the door outside belt portion to forcibly open the door, the operating rod 300 is applied with the shearing force F2 in a direction different from the longitudinal direction of the operating rod, such that the most vulnerable rupture part 460 is ruptured by the shearing force and thus the breaking of the operating rod 300 occurs.

Meanwhile, the outer circumferential portions of the other ends of the link rod 610 and the latch rod 630 are each provided with locking grooves 650 and the connection link 700 is provided to enclose the other ends of the link rod 610 and the latch rod 630, and locking protrusions 731 may be provided inside of the connection link 700 to be locked with the locking grooves 650. That is, a central portion of the connection link 700 is provided with the rupture part 460 and both ends of the connection link 700 are provided with insertion grooves (no reference numeral) in the longitudinal direction toward the rupture part 460 from both ends of the connection link 700 so that the other end of the link rod 610 or the other end of the latch rod 630 may be inserted into both ends of the connection link 700 based on the rupture part 460 and an inner circumferential surface of the insertion grooves (no reference numeral) is provided with the locking protrusion 731 so as to be locked with the locking groove 650.

The locking groove 650 is formed in a circumferential direction along the other end of the link rod 610 or the other end of the latch rod 630, such that when the link rod 610 or the latch rod 630 is inserted into the locking groove 650, the locking groove 650 may be locked with the locking protrusion 731.

As the locking groove 650 and the locking protrusion 731 are provided, it is possible to prevent the link rod 610 and the latch rod 630 from being separated from the connection link 700 and transfer the operating force depending on the rotation of the rotating link 120 to the latch device 400.

Meanwhile, the connection link 700 may be provided with holes 710 at circumferential portions facing the locking groove 650 and one end of the hole 710 may be provided with an elastic panel 730 of which the one end is connected with a circumferential portion of the hole 710 and the other end is provided with the locking protrusion 731.

In more detail, the hole 710 may be provided at a side wall portion of the connection link 700 and the hole 710 may be formed to communicate the inside of the connection link 700 with the outside thereof. The shape of the hole 710 may be various, but the shape of the hole 710 may be, for example, a shape of a long hole formed in the longitudinal direction of the connection link 700, for example, a rectangular long hole formed in the longitudinal length of the connection link 700 and one end of the elastic panel 730 may be formed to extend inside the hole 710 toward the insertion direction of the link rod 610 or the latch rod 630 from an inlet side into which the link rod 610 or the latch rod 630 are inserted among the circumferential portion of the hole 710.

Therefore, when the link rod 610 or the latch rod 630 is inserted into the connection link 700, the elastic panel 730 may move elastically, such that the locking protrusion 731 may be locked with the locking groove 650 without any difficulty. Further, as the locking protrusion 731 is formed on the elastic panel 730, even when the link rod 610 or the latch rod 630 is separated from the connection link 700, the other end of the elastic panel 730 pushes to the outside of the connection link 700 and then is separated, such that even though the rupture part 460 is ruptured due to the shearing force, the rupture part 460 may be easily replaced.

A pair of the hole 710 is each formed at both sides of the connection link 700 but is formed to face each other, such that when the link rod 610 or the latch rod 630 are inserted, each rod may be stably supported at both sides.

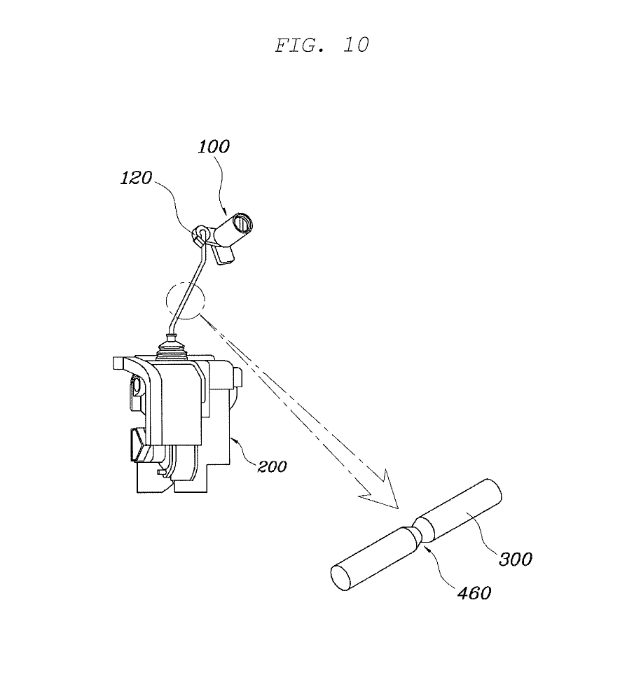

Meanwhile, FIG. 10 is a configuration diagram of a door lock device for a vehicle according to a third exemplary embodiment of the present invention, and in the door lock device for a vehicle according to the third embodiment of the present invention, the operating rod 300 is configured to include one rod and the rupture part 460 may be a notch formed along the outer circumference of the operating rod 300, in which the notch may be formed between one end and the other end of the operating rod 300.

Differently from the first and second exemplary embodiments of the present invention, according to the third exemplary embodiment of the present invention, as the rupture part 460 is directly formed in the operating rod 300, the additional costs caused by the rupture member or the connection link may not be required and the manufacturing and installation may be simple. The size of the shearing force ruptured due to the change in the notch thickness and the shape of the rupture part 460 may be set.

The door lock device for a vehicle according to various embodiments of the present invention may be commonly applied to all the vehicles which perform the locking using the operating rod and the latch device, thereby saving the time and costs for the separate design.

Further, even though the rupture member or the connection link are broken due to the theft attempt, the door lock device may be again recovered to the normal state by replacing only the rupture member or the connection link, thereby improving the anti-theft function and greatly saving the maintenance cost.

According to the door lock device for a vehicle of various embodiments of the present invention, the operating rod connecting the key set with the latch device is configured to be able to separated and thus is cut and separated when the external force to forcibly unlock the locking state for the door is applied, such that the latch device may prevent the locking state of the door from being unlocked, thereby preventing the vehicle theft.

Further, according to various embodiments of the present invention, the existing operating rod is configured to be separated and only the rupture member or the connection link which connects the separated rods with each other is applied, such that the necessity for the additional installation space for the anti-theft device is removed, thereby being free from the limitation in layout and preventing the interference with other parts.

In addition, according to various embodiments of the present invention, it is possible to reduce the working time to apply the anti-theft device, improve the assembling convenience, and reduce the manufacturing costs.

Further, the respective separated operating rods is again connected with each other by replacing only the rupture member or the connection link when the rupture member is ruptured due to the theft attempt, such that the door lock device for a vehicle may be easily recovered to the normal state.

For convenience in explanation and accurate definition in the appended claims, the terms “upper” or “lower”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door lock device for a vehicle, comprising:
a key set configured to include a rotating link which rotates depending on an operation of an inserted key;
a latch device configured to receive an operating force from the key set to selectively lock or unlock a door;
an operating rod configured to connect the rotating link of the key set with the latch device to convert a rotating displacement of the rotating link into a linear displacement and provide the converted linear displacement to the latch device as the operating force; and
a rupture part configured to be provided between both ends of the operating rod to break the operating rod when an external force other than the operating force provided from the rotating link to the latch device is applied to the operating rod.

2. The door lock device for a vehicle of claim 1, wherein the operating rod is configured to include a first rod which is connected with the rotating link of the key set, a second rod which is connected with the latch device, and a rupture member which connects the first rod with the second rod, wherein
the first rod and the second rod transferring the operating force depending on a key operation as the operating force of the latch device in a state in which the first and second rods are connected with each other by the rupture member, and
the rupture member is provided with the rupture part which is formed on a connection portion between the first rod and the second rod and is ruptured when a force is applied in a direction different from an operating direction in which the operating force of the operating rod is transferred.

3. The door lock device for a vehicle of claim 2, wherein the first rod of the operating rod is configured to include a first extending part which is connected with the rotating link of the key set and extends to the latch device and a first bending part which is bent at an end of the first extending part, and
the second rod is configured to include a second extending part which is connected with the latch device and extends to correspond to the first rod and a second bending part which is bent at an end of the second extending part.

4. The door lock device for a vehicle of claim 3, wherein the first bending part and the second bending part of the operating rod are bent in a direction substantially perpendicular to the operating direction in which the operating force is applied.

5. The door lock device for a vehicle of claim 4, wherein the first bending part and the second bending part of the operating rod are bent substantially in the same direction.

6. The door lock device for a vehicle of claim 3, wherein the rupture member is configured to include a first connection part and a second connection part which are connected with the first rod and the second rod of the operating rod, respectively, and the rupture part which connects the first connection part with the second connection part and is ruptured when the force is applied in the direction different from the operating direction of the operation rod.

7. The door lock device for a vehicle of claim 6, wherein the first connection part and the second connection part of the rupture member are provided with fixing hole parts into which the first bending part and the second bending part of the operating rod are inserted.

8. The door lock device for a vehicle of claim 7, wherein the rupture part of the rupture member is formed on outer circumferential surfaces of the fixing hole parts which are formed in the first connection part and the second connection part to connect the first connect part with the second connect part.

9. The door lock device for a vehicle of claim 6, wherein the first connection part and the second connection part of the rupture member are each provided with joining parts which enclose the first extending part and the second extending part of the operating rod.

10. The door lock device for a vehicle of claim 9, wherein each of the joining parts of the first connection part and the second connection part is provided with combining parts to mount the rupture member on the operating rod when enclosing each of the extending parts of the operating rod and then being fastened therewith.

11. The door lock device for a vehicle of claim 1, wherein the operating rod includes:
a link rod, one end of which is connected with the rotating link;
a latch rod, one end of which is connected with the latch device; and
a connection link, both ends of which are connected with the other ends of the link rod and the latch rod, respectively.

12. The door lock device for a vehicle of claim 11, wherein a notch is formed between the both ends of the connection link along a circumference of the connection link to form the rupture part.

13. The door lock device for a vehicle of claim 11, wherein outer circumferential portions of the other ends of the link rod and the latch rod are each provided with locking grooves, the connection link is provided to enclose the other ends of the link rod and the latch rod, and locking protrusions are provided inside of the connection link to be locked with the locking grooves.

14. The door lock device for a vehicle of claim 13, wherein the connection link is provided with a plurality of holes at circumferential portions facing the corresponding locking grooves and one end of each hole is provided with an elastic panel of which one end is connected with a circumferential portion of the hole and the other end is provided with a locking protrusion in the locking protrusions.

15. The door lock device for a vehicle of claim 14, wherein the hole has a long hole shape formed in a longitudinal direction of the connection link and the one end of the elastic panel is connected with a circumferential portion of an inlet side into which the link rod or the latch rod is inserted.

16. The door lock device for a vehicle of claim 14, wherein the holes are formed in pair at both sides of the connection link, respectively, and formed to face each other.

17. The door lock device for a vehicle of claim 1, wherein the rupture part is a notch which is formed along an outer circumference of the operating rod.
